(19) United States
(12) Patent Application Publication
(10) Pub. No.: US 2005/0242966 A1
(43) Pub. Date: Nov. 3, 2005

(54) Vessel liquid overflow detector

(76) Inventors: David Picco, Carlsbad, CA (US); Ibrahim Hanna Makhlouf, Fullerton, CA (US); Rick Slemmer, San Diego, CA (US); Gerald William Maliszewski, San Diego, CA (US)

Correspondence Address: LAW OFFICE OF GERALD MALISZEWSKI, P.O. BOX 270829, SAN DIEGO, CA, 92198-2829, US

(21) Appl. No.: 11/115,658

(22) Filed: Apr. 27, 2005

Related U.S. Application Data
(60) Provisional application No. 60/565,988, filed on Apr. 28, 2004.

(51) Int. Cl. G08B 21/00

(52) U.S. Cl. 340/616; 340/619

(57) ABSTRACT

A liquid-surface detection assembly, a vessel-integral overflow detector, and trans-surface field sensor designs are provided. The detection assembly comprises a trans-surface liquid detection field aligned in a horizontal plane, and a detection signal interface to supply a signal responsive to the detection of liquid surface across the liquid detection field. The trans-surface liquid detection field includes a first set of sensors with horizontal plane mounting interfaces, and the detection signal interface supplies a signal responsive to the measurement of electrical resistance between sensors in the first set. Sensor designs and mounting interfaces specifically tailored for use in a trans-surface field are also presented. Grid, sieve, and tube housing designs are presented that minimize incidental contact with sensor electrodes, but that are able to measure the presence of steady-state liquid surface. These designs also permit a detector to be enabled as a single-station.

### BACKGROUND OF THE INVENTION

1. Field of the Invention

This invention generally relates to emergency alarm sensors and, more particularly, to a system for detecting the overflow of a liquid from a vessel, such as the overflow of water from a bathtub.

2. Description of the Related Art

Plumbing failures in residential and commercial building result in millions of dollars of damage each year, in this country alone. As a result, systems have been designed to detect pools of water or leakage from a pipe. Other systems have been designed to detect the pooling of water on a floor surface. One mode of flooding, occurring in homes, institutions, and commercial facilities, involves the overfilling and overflow of a vessel such as a bathtub. As is well understood, it takes several minutes to fill a bathtub, and people often engage in other activities during this time. Occasionally, people get carried away with these other activities, or lose track of time. Even if a tub is designed with an overflow drain near the tub rim, the drain is not always sufficiently large to keep up with the incoming water flow. In this case, the tub overflows and significant damage is likely to result.

Numerous applications exist for liquid-containing vessels that monitor the incoming water level, and shut off the incoming water at a predetermined level. A toilet bowl float regulator is one example of such a system. However, a water regulation system may add cost, space, or an unappealing aesthetic, and there are many applications where these additional considerations are deemed more important than safety. Further, there are many applications where a monitor/regulator system cannot be retrofitted to an existing vessel, even if such a system could be found. Again using a bathtub as an example, there are no practical water regulators existing that can be retrofitted to a bathtub, to turn off the water flow at a predetermined level. Although a bathtub has been used as an example, there are also numerous commercial and industrial vessels that are filled by manually operating faucets or valves, which could benefit from an additional level of safety, even if that additional level was only an alarm.

Conductive liquid sensors are known that consist of two electrically conductive materials formed on an insulating material in close proximity, but without touching. When liquid bridges across the two conductive materials, the resistance between the conductive materials drops. This reduction in resistance is monitored, and a decrease in resistance is assumed to indicate the presence of liquid. This method provides an economical means to sense liquid on floor surfaces due to leaks in pipes, failed fittings, leaking valves, and floods.

However, these sensors are essentially two-dimensional. They can be located over a wall or a floor, for example, to detect the presence of water. However, these sensors are not sufficiently subtle to detect a flood condition manifested as a uniform rise in the water level across a water surface. Alternately stated, these sensors are unable to distinguish between the presence of water in just a particular region, and the occasional splash of water, from a genuine, steady-state rise in water level.

It would be advantageous if a liquid detection sensor could monitor the overflow of liquid from a vessel such a bathtub, without the occurrence of false positives.

It would be advantageous if a liquid detection sensor could be devised that responded only to a uniform rise in a liquid surface level.

### SUMMARY OF THE INVENTION

The present invention is a sensor system that can be used to detect the full state (about to overflow) of a liquid in a vessel. One practical application of such a system is as a bathtub overflow detector.

Accordingly, a liquid-surface detection assembly is provided. The detection assembly comprises a trans-surface liquid detection field aligned in a first horizontal plane, and a detection signal interface to supply a signal responsive to the detection of liquid surface across the liquid detection field. The trans-surface liquid detection field includes a first set of sensors with horizontal plane mounting interfaces, and the detection signal interface supplies a signal responsive to the measurement of electrical resistance between sensors in the first set.

The horizontal plane mounting interface can be a tub-edge clip, suction cup with visual alignment markers, adhesive backing with visual alignment markers, or a partial tub-side hanger, as is described in more detail below. All the above-mentioned mounting interfaces share the common feature of permitting the sensors to be aligned in a common horizontal plane.

In another aspect, the detection assembly further comprises an alarm unit having an input connected to the detection signal interface to receive signals from the first set of sensors, and an output to supply an alarm signal. In other aspect, the alarm signal can be programmed to be responsive the factors such as a measured resistance value, the time duration of a resistance value measurement, the duration between measurements of a resistance value, or the frequency of a measured resistance value.

Sensor designs specifically tailored for use in a trans-surface field are also presented. Grid, sieve, and tube housing designs are presented that minimize incidental contact with sensor electrodes, but that are able to measure the presence of steady-state liquid surface. These designs also permit a detector to be enabled as a single-station.

Additional details of the above-described detector assembly, a liquid-containing vessel with vessel-mounted sensors, and a liquid vessel with overflow protection are provided below.

### BRIEF DESCRIPTION OF THE DRAWINGS

FIG. 1 is a perspective view of a liquid-surface detection assembly.

FIG. 2 is a partial cross-sectional perspective view depicting a first aspect of the assembly of FIG. 1.

FIG. 3 is a partial cross-sectional perspective drawing depicting a second aspect of the assembly of FIG. 1.

FIGS. 4A through 4E are drawings depicting some exemplary mounting interfaces for the sensors of FIGS. 2 and 3.

FIG. 5 is a partial cross-sectional view of a third aspect of the liquid-surface detection assembly of FIG. 1.

FIG. 6 is a partial cross-sectional view of a fourth aspect of the liquid-surface detection assembly of FIG. 1.

FIGS. 7A through 7I are detailed views of sensors specifically designed for use in a trans-surface field.

FIG. 8 is a partial cross-sectional view of a liquid vessel with an overflow protection system.

FIGS. 9A through 9C are detailed drawings of some vessel-integral sensor designs.

FIG. 10 is a flowchart illustrating a method for detecting the overflow of liquid in a vessel.

### DETAILED DESCRIPTION OF THE DRAWINGS

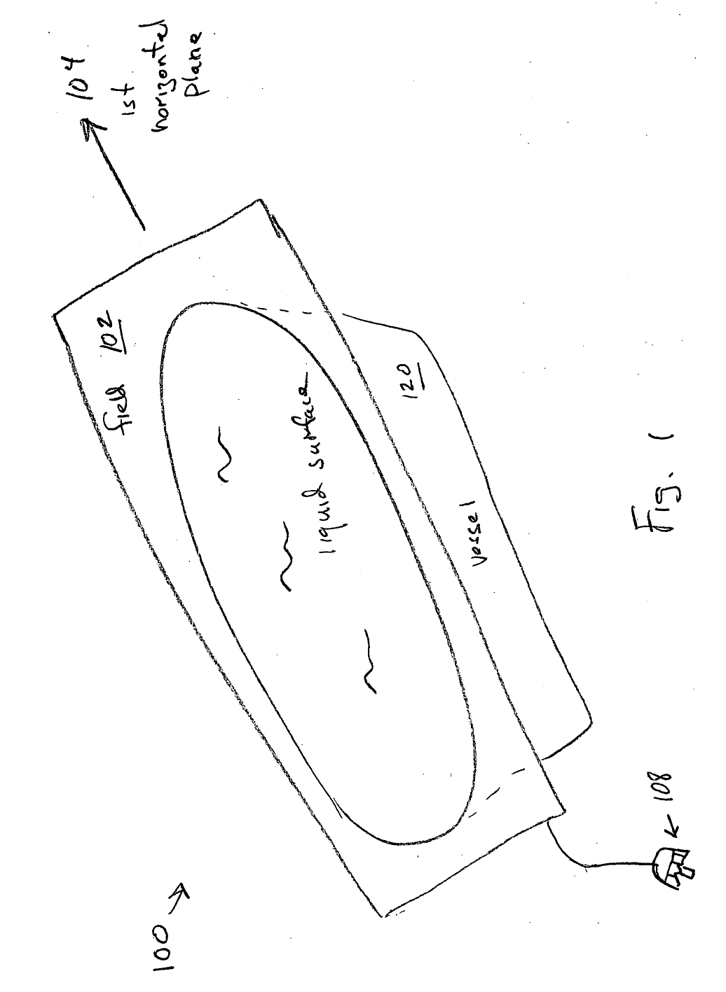

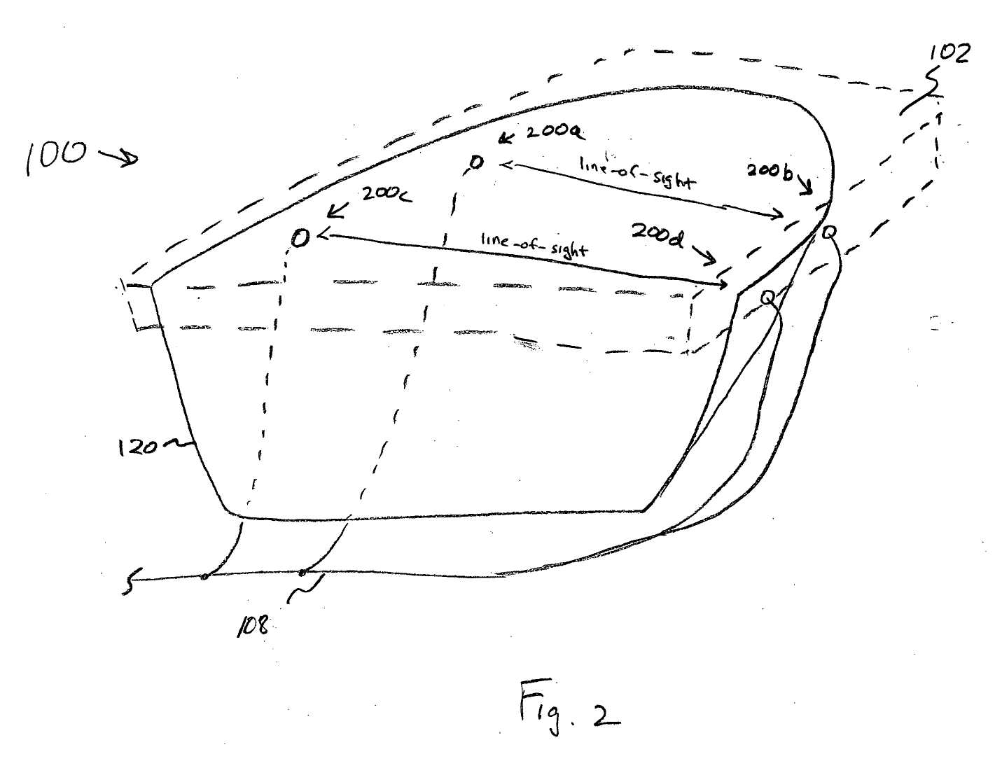

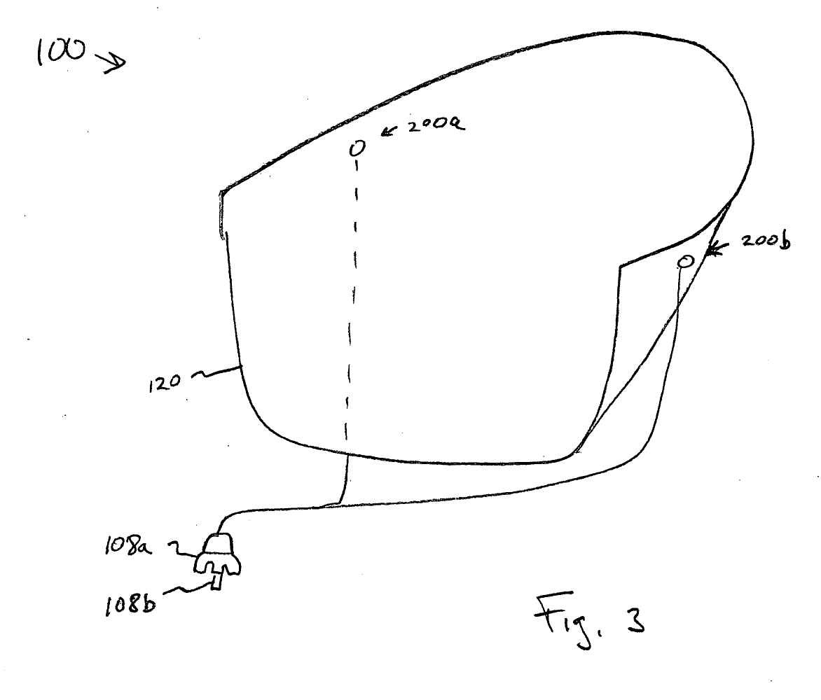

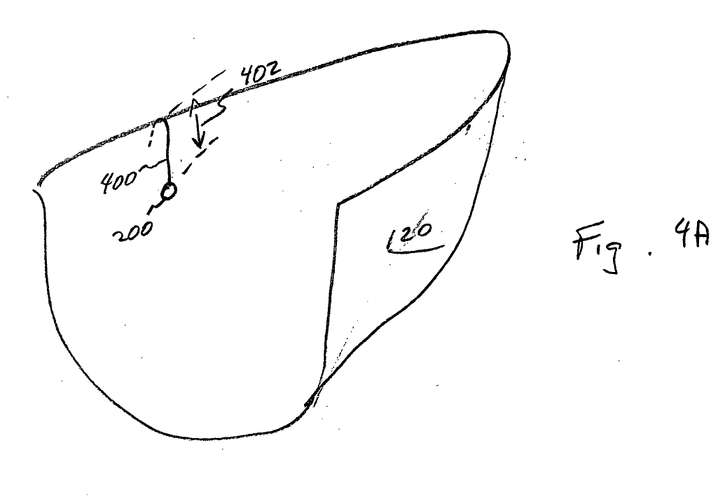

FIG. 1 is a perspective view of a liquid-surface detection assembly. The liquid-surface detection assembly 100 comprises a trans-surface liquid detection field 102 aligned in a first horizontal plane 104. The assembly 100 also comprises a detection signal interface 108 to supply a signal responsive to the detection of liquid surface across the liquid detection field 104. The detection signal interface 108 is depicted as a wire medium with a connector. However, the invention is not limited to any particular connector style or conduction medium. Alternately, the detection signal interface 108 may be wireless.

Also shown is a liquid-containing vessel 120. For example, the vessel 120 can be an oval shaped bathtub, as shown. In other aspects, the vessel may be the cargo hold of a ship or a truck-transported mobile tank. The present invention is not limited to any particular vessel shape, vessel function, or type of liquid.

FIG. 2 is a partial cross-sectional perspective view depicting a first aspect of the assembly of FIG. 1. The trans-surface liquid detection field 102 includes a first set of sensors 200. The sensors 200 may optically detect the presence of a liquid between sensor pair 200a and 200b. In the case of optical sensors, multiple pairs of sensors may be desirable in the event the optical obstruction is something other than a liquid. For example, the obstruction can be a mixing rod, or the limb of a person using a bathtub. Shown are sensor pair 200c and 200d. A separate signal may be generated for each sensor pair, or sensor pairs may be summed to provide a single signal. For example, sensor 200a may be summed with 200c, and sensor 200b summed with 200d, so that a non-detection signal is sent as long as either, or both, of the sensor pairs 200a/200b and 200c/200d remain unobstructed. The present invention is not limited to the number of sensors or sensor pairs. For example, sensors 200a and 200b may be an optical transmitter and receiver, respectively, or an optical transceiver and reflector pair. These optical sensors may operate in a manner similar to garage door sensors.

FIG. 3 is a partial cross-sectional perspective drawing depicting a second aspect of the assembly of FIG. 1. As an alternative to optical sensors, electrically conductive sensors may also be used. In one simple form the sensors 200 can be a metal, such as copper. An electrical circuit is completed when a liquid bridges sensor 200a to 200b. Thus, the sensors may also be referred to as liquid contacts. The detection signal interface 108 supplies a signal responsive to the measurement of electrical resistance between sensors 200a and 200b. Alternately stated, a very large resistance is measured between contacts 108a and 108b when there is no liquid between sensors 200a and 200b. The resistance typically decreases several orders of magnitude when a liquid is present between sensors 200a and 200b. These types of sensors are well known, and a more detailed description is unnecessary to one skilled in the art.

One advantage to electrically conductive sensors, besides cost, is that alignment is less critical, as compared to optical sensors. Further, since optic line-of-sight is not an issue, a single pair of sensors is typically sufficient to enable the invention. However, as with the optical sensors, more than two sensors may be used. Further, the electrically conductive sensors can be paired to create separate signals, or summed to create a single signal. In a multi-electrode aspect, the resistance between different electrode pairs may be differentially weighted. The sensors 200 can be electrically conductive metallic electrodes, metallic tape, or a conductive ink strip, to name a few examples.

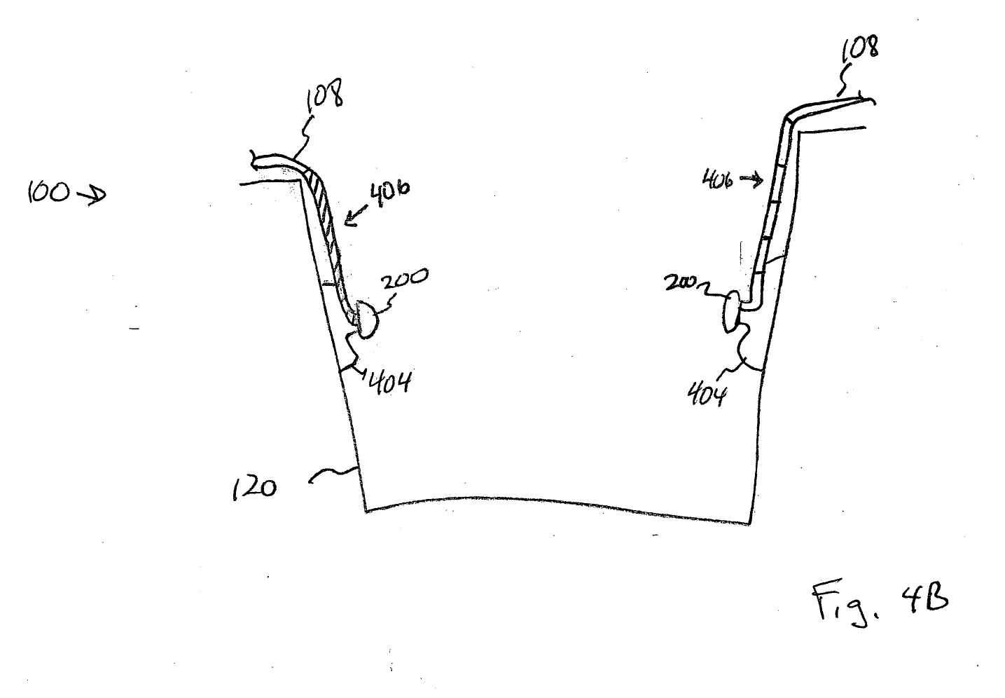

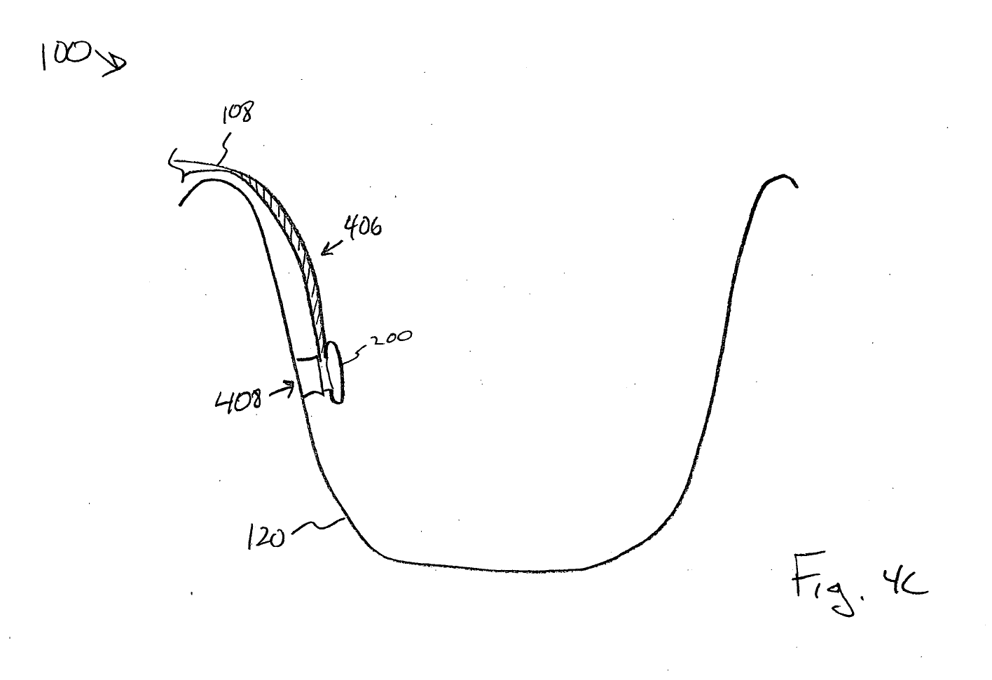

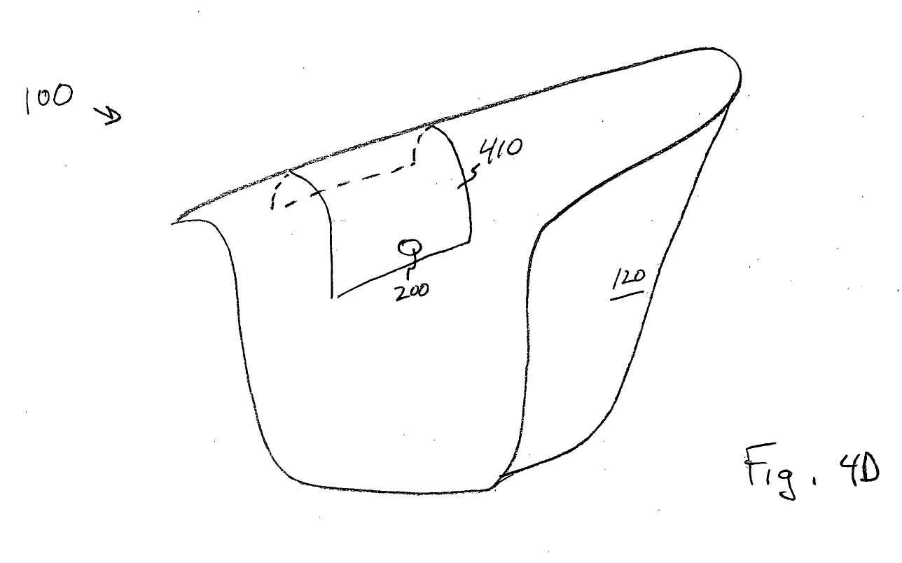

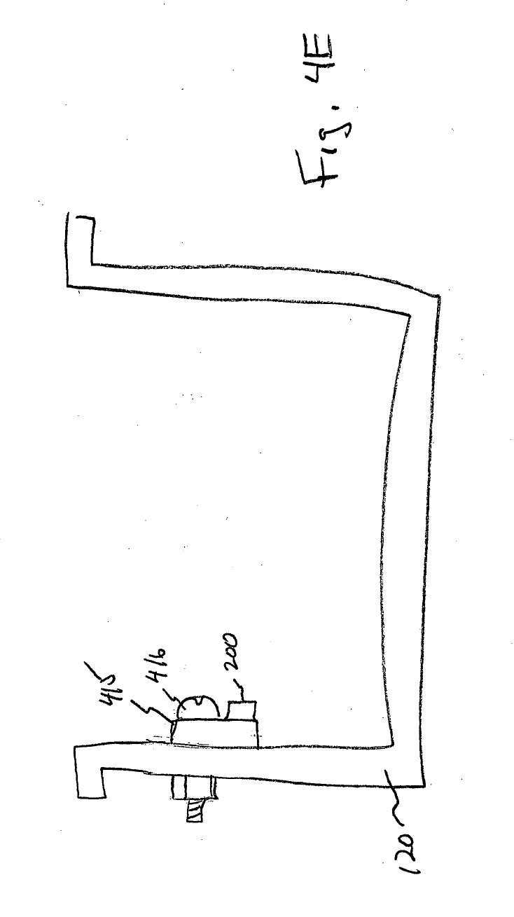

FIGS. 4A through 4G are drawings depicting some exemplary mounting interfaces for the sensors of FIGS. 2 and 3. FIG. 4A depicts a sensor 200 with a tub-edge clip 400 mounting interface. The clip 400 permits the sensor to be easily mounted, removed, or relocated. The clip 400 has a length 402 that advantageously permits multiple sensors to be hung in the same horizontal plane to increase the accuracy of the measurements.

FIG. 4B depicts a sensor 200 having a suction cup 404 mounting interface, with visual alignment markers 406. In this aspect, the wires of the detection signal interface 108 are color coded, ruled, or marked in some manner that permit the suction cups to be placed an equal distance from the lip of a vessel 120 or tub. The suction cups 404 permit the sensor 200 to be easily installed, removed, or relocated. In addition, the level of the first horizontal plane (see FIG. 1) can be varied in accordance with the user's needs.

FIG. 4C depicts a sensor 200 having an adhesive backing 408 mounting interface, with visual alignment markers 406. As with the alignment markers of FIG. 4B, the wires of the detection signal interface 108 can color coded, ruled, or marked in some manner that permit all the sensors to be placed an equal distance from the lip of a vessel 120 or tub. The adhesive backing 408 permits the sensor 200 to be easily installed, removed, or relocated. In addition, the level of the first horizontal plane (see FIG. 1) can be varied in accordance with the user's needs. Alternately, the mounting interface 408 can be a non-liquid-soluble putty or a magnetic mount (for metallic vessels 120).

FIG. 4D depicts a sensor 200 embedded in a partial tub-side hanger 410. The hanger can be shaped to compliment the tub shape. Here, the hanger 410 is seen as rounded to fit a rounded tub rim. The prefabricated form of the hanger 410 ensures that the sensors 200 will be aligned in a common horizontal plane.

Alternately considered, the sensors 200 may be enabled with mounting interfaces specifically designed for engaging a sensor with a liquid-containing vessel, particularly the sides of a vessel. The tub-edge clips of FIG. 4A, the suction cups of FIG. 4B, the adhesive backing of FIG. 4C, and the partial tub-side hanger of FIG. 4D are all examples of vessel-engageable interfaces.

FIG. 4E is a perspective drawing depicting a mounting interface 415 made for bolt 416 mounting into a hole in the side of a vessel. A washer or sealant (not shown) may be used to ensure that liquid does not escape the vessel 120. Although a detection signal interface is not specifically shown, it can be a wireless transmitter embedded with the sensor 200, a wire running over to lip of the vessel 120, or a wire through the vessel 120.

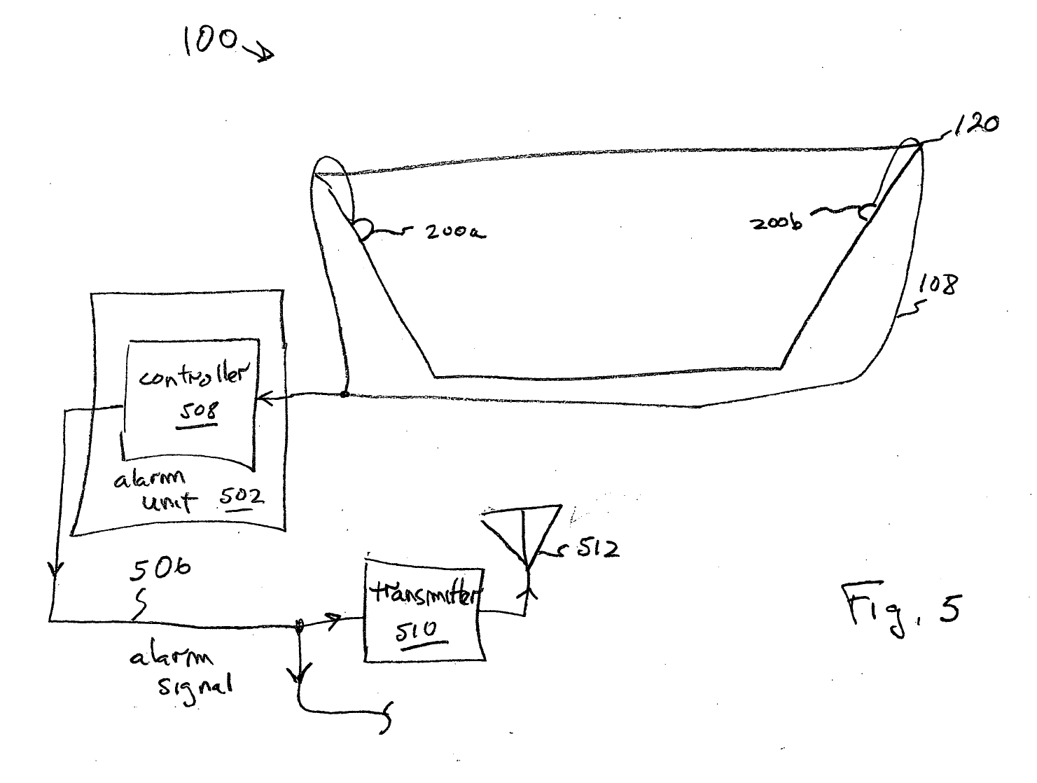

FIG. 5 is a partial cross-sectional view of a third aspect of the liquid-surface detection assembly of FIG. 1. More particularly, the sensors 200a and 200b are shown mounted on opposite ends of a bathtub 120. Note, the sensors are not limited to this configuration. In other aspects not shown, the electrodes can be located along opposite sides considered with respect to width, or at a diagonal. The definition of opposite also varies with the shape of the vessel 120.

Also shown is an alarm unit 502 having an input connected to the detection signal interface 108 to receive signals from the first set of sensors 200a and 200b. The alarm unit 502 has an output on line 506 to supply an alarm signal.

In one aspect, the alarm unit 502 includes a controller 508 having an input to receive the signals from the first set of sensors 200a and 200b. The controller 508 has an output on line 506 to supply the alarm signal in response to an analysis of factors such as a measured resistance value. For example, the alarm signal is sent in response to a resistance measured below a predetermined threshold resistance measurement. As is understood in the art, resistance measurements are proportional to voltage and current values. Alternately, the alarm signal can be responsive to the time duration of a resistance value measurement, for example, when the resistance is less than the predetermined resistance threshold for longer than 10 seconds.

In another aspect, the controller 508 supplies an alarm signal in response to the duration between measurements of a resistance value. For example, an alarm is sent if two resistance measurements lower than the threshold occur in less than a 2-second span. In another aspect, the alarm signal can be made responsive to the frequency of a measured resistance value. For example, an alarm signal can be generated if the measured resistance is lower than the threshold more often than once a second. In one aspect, different alarm criteria can be combined.

The present invention is not necessarily limited to the exemplary alarm criteria. Further, the alarm criteria may be set at the factory, selectable by the user, adjustable by the users, or programmable by the user. Generally, the above-mentioned algorithms can be used to minimize the number of false positive alarms. The occurrence of false positive alarms may startle small children to tears, frighten the infirmed, or generally annoy a person enjoying a hot bath.

The alarm signal on line 506 can be used to trigger an audible or visual alarm that directly warns a user. Alternately, the alarm signal be a wire medium electrical signal that is sent to a computer monitor, home security system, or cell telephone message, to name a few examples. These systems may, in turn, act to warn the user, or take an action such as triggering a valve that cuts the source of the liquid flow, or send a warning to a security monitoring organization. As shown, the alarm signal is shown being sent to an alarm unit wireless transmitter 510 and antenna 512 to transmit a wireless alarm signal.

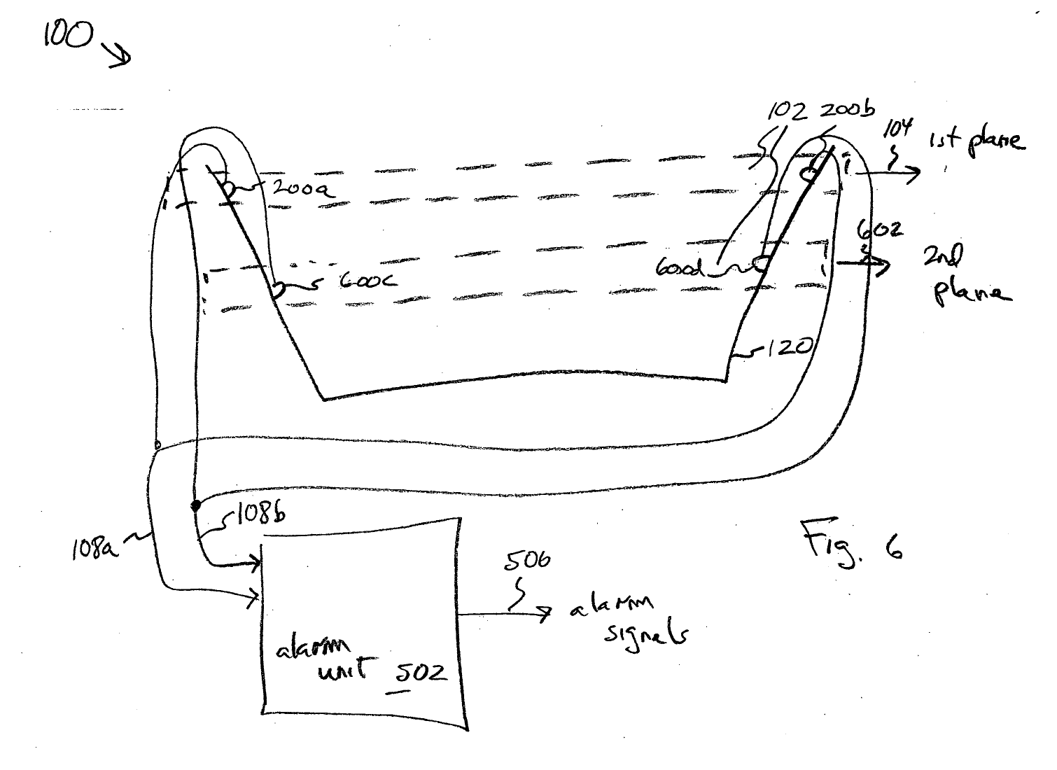

FIG. 6 is a partial cross-sectional view of a fourth aspect of the liquid-surface detection assembly of FIG. 1. The trans-surface liquid detection field 102 includes a second set of sensors 600 with mounting interfaces for alignment in a second horizontal plane 602, below the first horizontal plane 104. The detection signal interface 108 supplies a signal responsive to a measurement of electrical resistance between sensors 600 in the second set.

In one aspect, the alarm unit 502 has an input connected to the detection signal interface 108 to receive the signals associated with the first set of sensors 200 and the second set of sensors 600 (600a and 600b). For simplicity, separate lines 108a and 108b are shown for the different sensor sets 200 and 600, respectively. However, if the sensors provide digital signals, a shared line or wireless medium could differentiate the sensor signals by channel. For example, the signals on line 108b could supply a “full” signal in response to signals associated with the second set of sensors 600. The alarm signal can be a gentle reminder to alert the user that the tub has reached a desired level. If the liquid continues to flow and the first set of sensors 200 is triggered, as more strident alert can be generated.

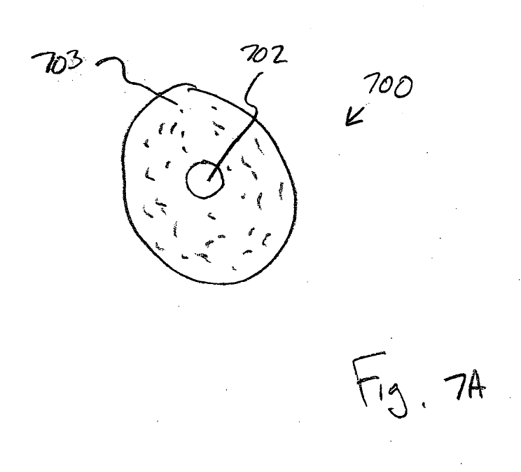

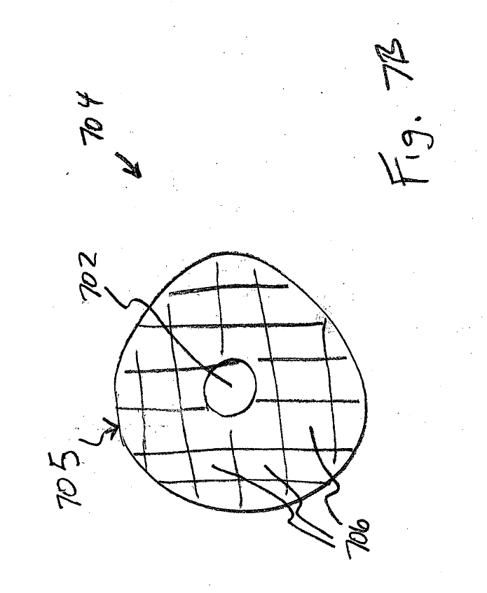

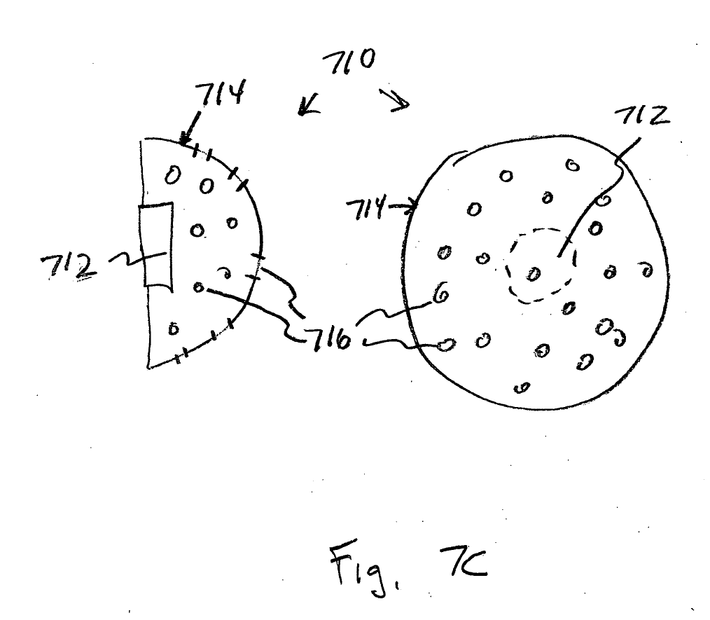

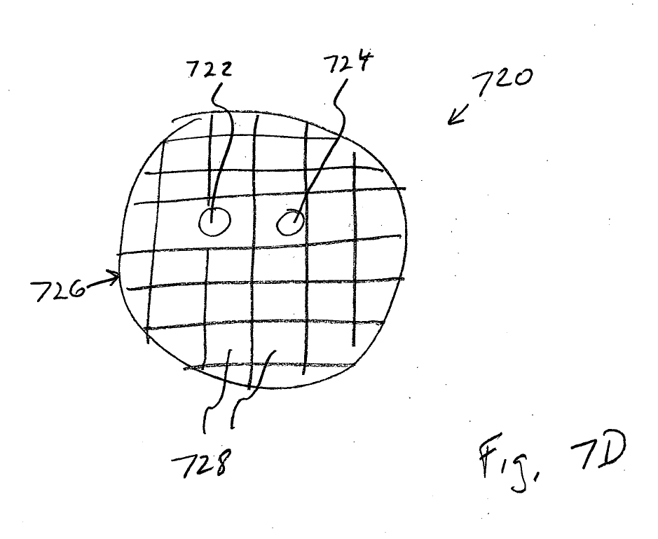

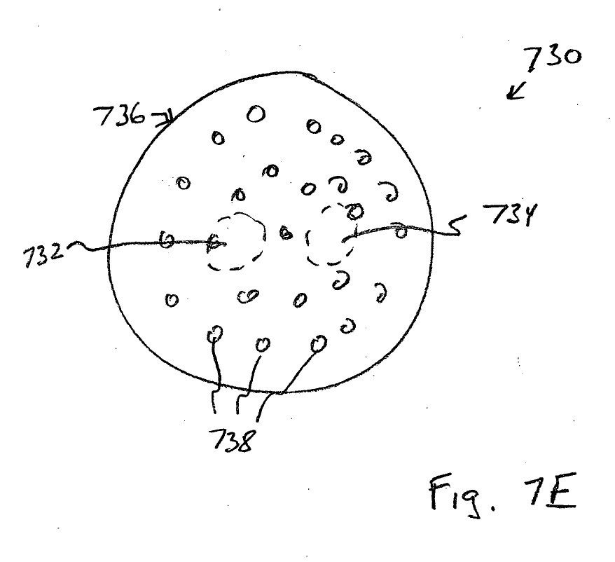

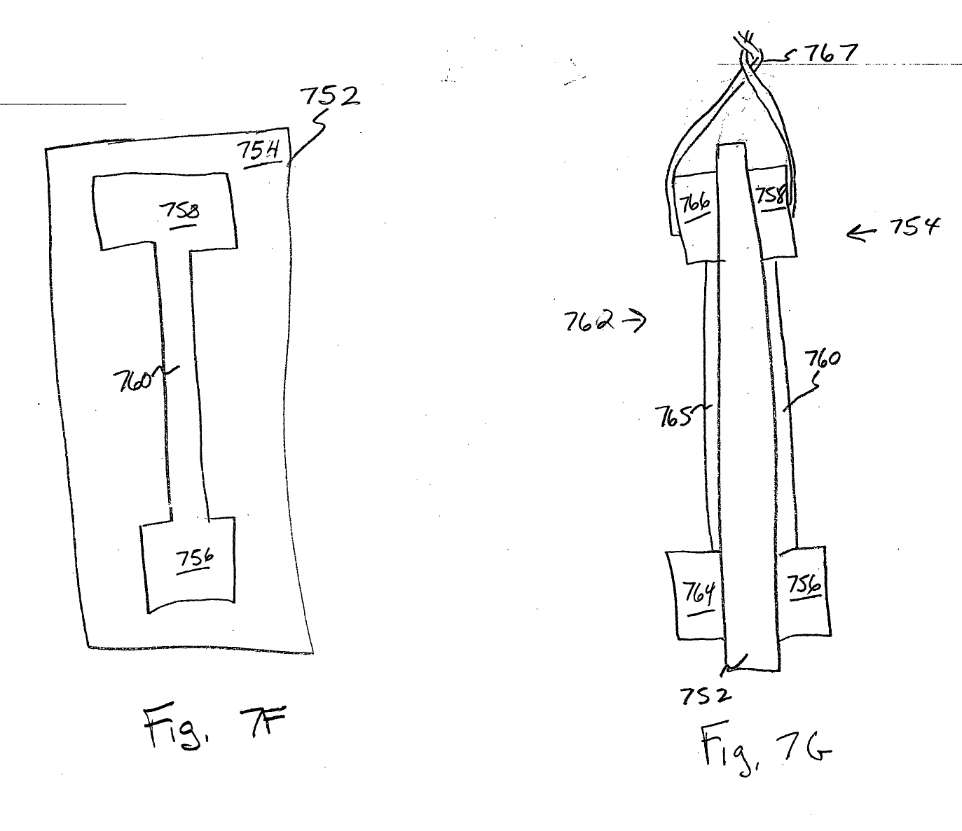

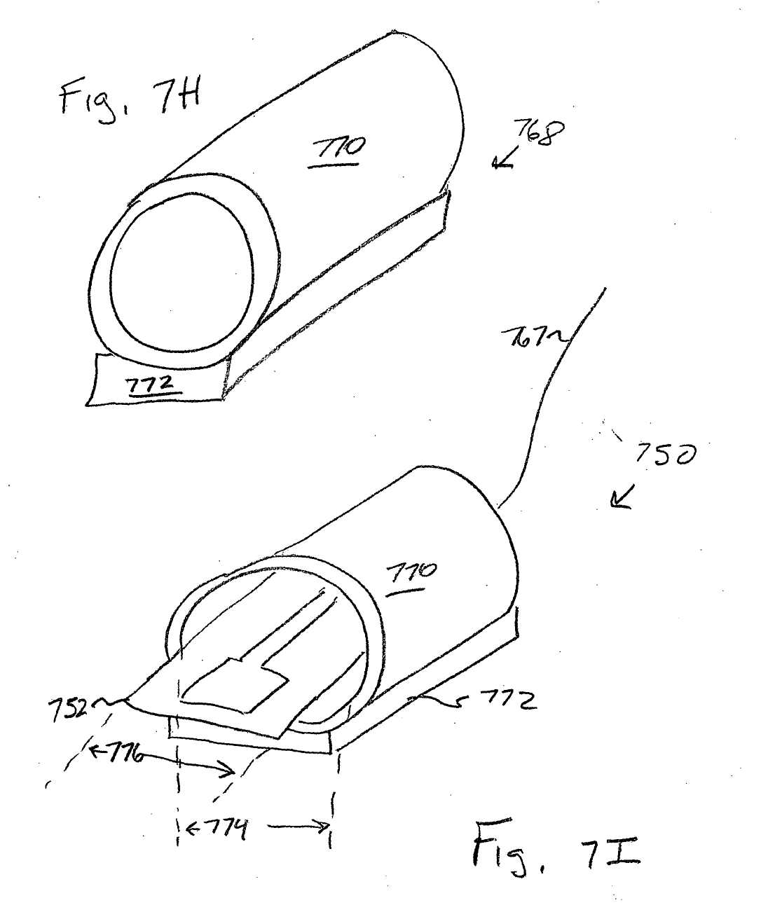

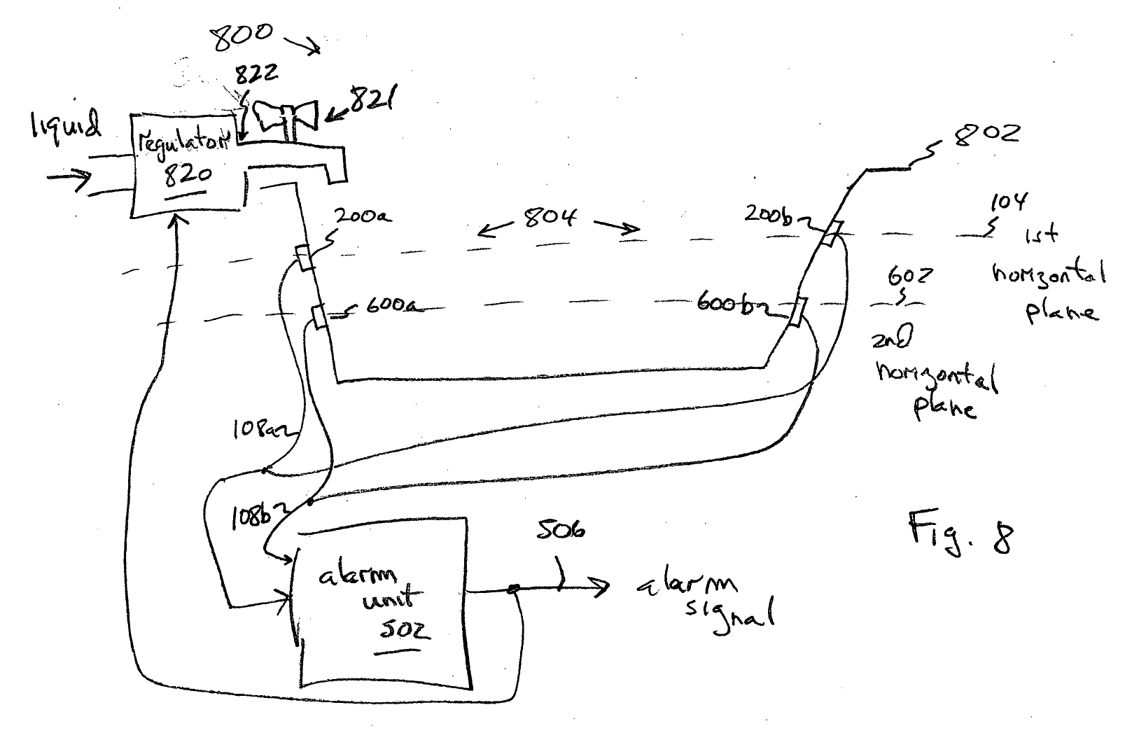

FIGS. 7A through 7I are detailed views of sensors specifically designed for use in a trans-surface field. As noted above, false positive signals can be minimized by using signal trigger algorithms. However, the occurrence of false positive signals can also be addressed in the design of the sensors. In FIG. 7A, a sensor 700 comprises a conductive electrode 702 surrounded by a foam rubber material 703. Soap bubbles are less likely to penetrate the foam rubber than water, so this type of sensor can be attached to the side of a bathtub and used to minimize the number of false positive signals caused by the bubbles.

In the grid-covered sensor 704 of FIG. 7B, material 705 forms a grid. For example, the grid can be a non-liquid-absorbent rubber-like material with passages 706. Alternately, the grid 705 can be a steel wool or plastic woven material, such as is used for scrubbing kitchen pots and pans. However, the invention is not limited to any particular type of material or passage design. The passages 706 in the grid 705 permit water access to the electrode 702, but the passages also permit water to drain. Further, water is not absorbed into grid material 705. Bubbles and intermittent splashes have difficulty in penetrating the maze of passages 706 to the electrode 702. The size and density of the passages 706 can be varied for different liquid viscosities.

In FIG. 7C, sieve-covered sensor 710 comprises an electrode 712 and a sieve wall 714. The sieve wall 714 protects the electrode 712 from intermittent splashes of water and from bubbles riding on the surface of a liquid. Holes 716 in the sieve wall 714 permit liquid to contact the electrode 712, and also permit any liquid contacting the electrode 712 to drain. A steady-state occurrence of water in the trans-surface field causes the sensor 710 to measure a low resistance, but the sieve wall 714 minimizes the occurrence of false positive signals. The size and density of the holes 716 can be optimized for the viscosities of different liquids. Although the sieve 714 is shown shaped as semi-spherical, other sieve shapes and orientations are also possible.

FIGS. 7D through 7E are partial cross-sectional view of a single-station trans-surface detector. The safety inherent in the design of the sensors of FIGS. 7A through 7C permits a single detector to be used to determine the presence of a water surface. In FIG. 7D, a grid sensor 720 has two electrodes 722 and 724 embedded in a grid 726. The grid 726 minimizes incidental liquid contact, due to splashes for example, but a steady-state occurrence of liquid, permitted entry by passages 728, can be measured as a low resistance between electrodes 722 and 724. The close proximity of electrodes 722 and 724 inherently insures that the trans-surface field established by the single-station sensor 720 is in a common horizontal plane.

Likewise, the sieve sensor 730 of FIG. 7E has two electrodes 732 and 734 protected by a sieve 736. The sieve 736 minimizes incidental liquid contact, due to splashes for example, but a steady-state occurrence of liquid, permitted entry through holes 738, can be measured as a low resistance between electrodes 732 and 734. Further, the close proximity of electrodes 732 and 734 inherently insures that the trans-surface field established by the single-station sensor 730 is in a common horizontal plane.

FIGS. 7F through 7I depicts views of a multiple surface single-station trans-surface detector. As shown in FIG. 7F, in one aspect the detector 750 comprises a board 752. For example, the board can be a circuit board made from a conventional dielectric material. Shown is the front side 754 of circuit board 752. The back side (see FIG. 7G) may be identical to the front side 754. Electrode or liquid contact 756 is connected to a solder contact 758 via a trace 760. For example, the solder contact, trace, and liquid contact may be tin plated copper.

FIG. 7G is a partial cross-sectional view of circuit board 752, showing front side 754 and back side 762. The back side 762 has a liquid contact 764, trace 765, and a solder contact 766. A sensor wire 767 with two leads is attached to solder contacts 766 and 758. Alternately but not shown, the solder contacts 766/758 nay be connected to a wireless transmitter.

FIG. 7H is a perspective view of a detector housing 768. As shown, the housing 768 includes a tube 770 and a mounting interface 772 that can be used to attach the housing 768 to a vessel such as a bathtub. For example, the housing can be a plastic or rubber-like material. FIG. 7I shows the circuit board 752 partially inserted into the housing 768. The tube 770 has an inside 774 diameter greater than the board width 776, so that the board can be accepted into the tube. Magnetic elements can be inserted in the mounting interface 772 to mount the detector on the sides of a metal vessel. Alternately, the housing can be adhesively attached, held in place with the sensor wire 767, held in place by a clip or hook, suction cup, or any of the above-mentioned mounting means.

The detector 750 employs two mechanisms for preventing the occurrence of false positive signals. First, the housing 768 prevents an intermittent splash from triggering the device. Second, the location of liquid contacts 756 and 764 on opposite board sides also prevents intermittent connection of the liquid contacts through a liquid medium. Ideally, the detector 770 is only triggered by a uniform, persistent rise in the level of a liquid. Although a tube-shaped housing is depicted, other shapes are possible. Likewise, although liquid contacts are shown mounted on opposite sides of a circuit board are shown, other arrangements are possible. For example, the liquid contacts may be mounted on opposite sides of the circuit, as shown, but at different horizontal planes for increased security from accidental triggers. The liquid contacts may be mounted on the same side of the circuit board in the same horizontal plane, or on the same side of the circuit board in different horizontal planes. In a different aspect, the liquid contacts can be mounted on separate circuit boards. Further, the separate circuits boards may be separated by a baffle, located in different chambers of a housing, or located in different housings.

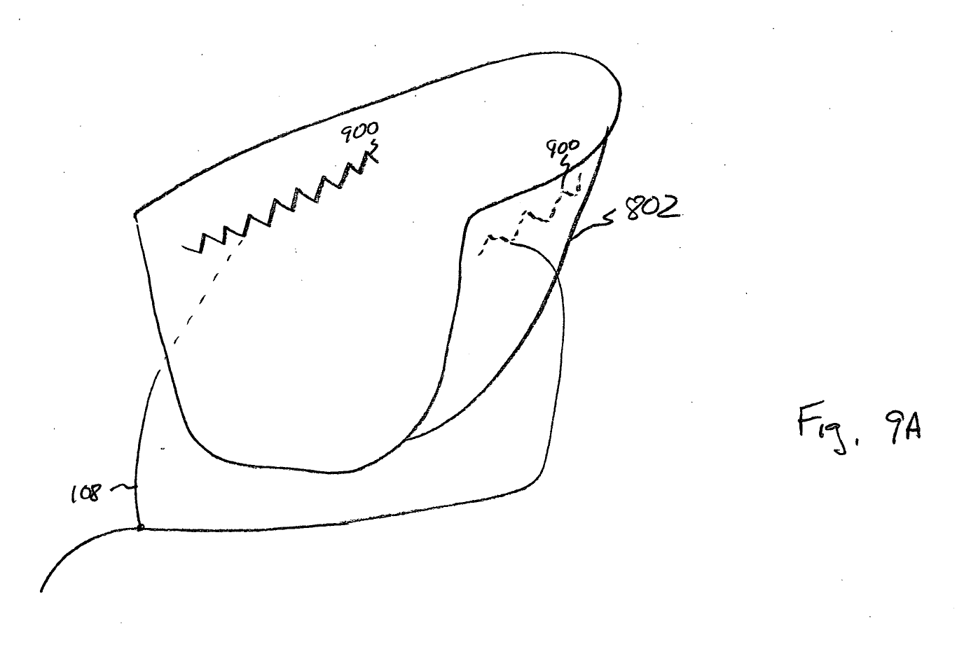

FIG. 8 is a partial cross-sectional view of a liquid vessel with an overflow protection system. The system 800 comprises a vessel 802 with interior sides 804. A first set of sensors 200 are mounted to the interior sides 804 of the vessel 802. A detection signal interface 108 supplies a signal responsive to the detection of a liquid between the sensors 200a and 200b. The first set of sensors 200 is aligned in a first horizontal plane 104. Whereas the sensors shown in FIGS. 1, 2, and 3 are primarily retrofitted onto existing vessels, the system of FIG. 8 is “built into” the vessel, as an integral part of the vessel design. As described in the explanation of FIGS. 2 and 3, the sensors can be electrically conductive, to measure resistance, or optical to detect an obstructed line-of-sight. In the interest of brevity, common features of the integral-design sensors will not be repeated.

Typically as shown, the first set of sensors 200 are mounted on opposite sides of the vessel to minimize of occurrence of false positive signals due to splashing. For example, vessel 802 may be an oval bathtub, with the sensors oriented at the head and foot of the tub. However, other sensor orientations are also possible. Further, the sensors need not be on opposite sides, as non-opposite orientations may be less susceptible to false positive signals in some scenarios.

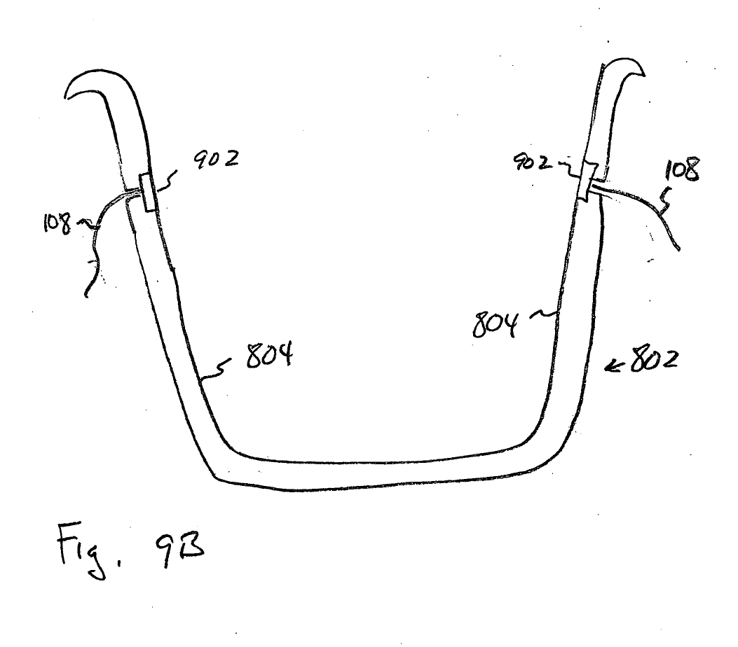

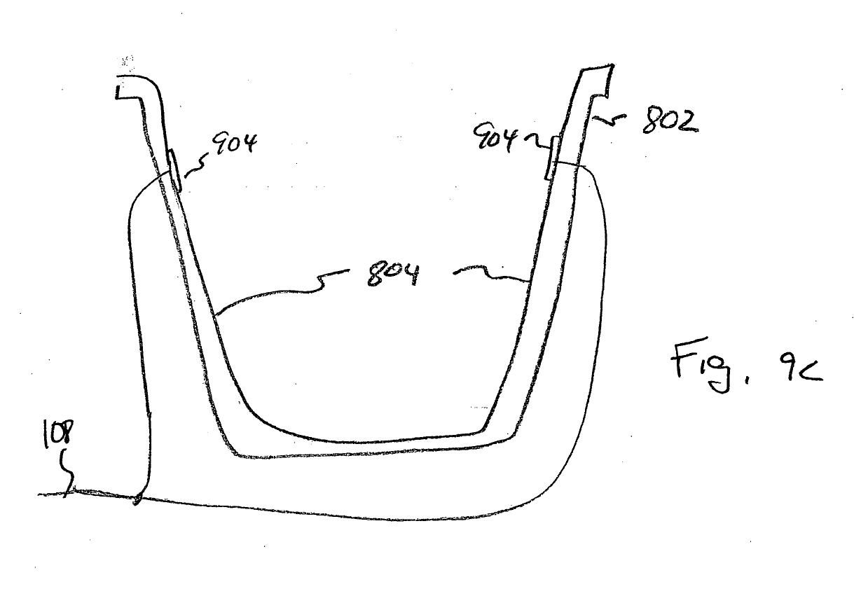

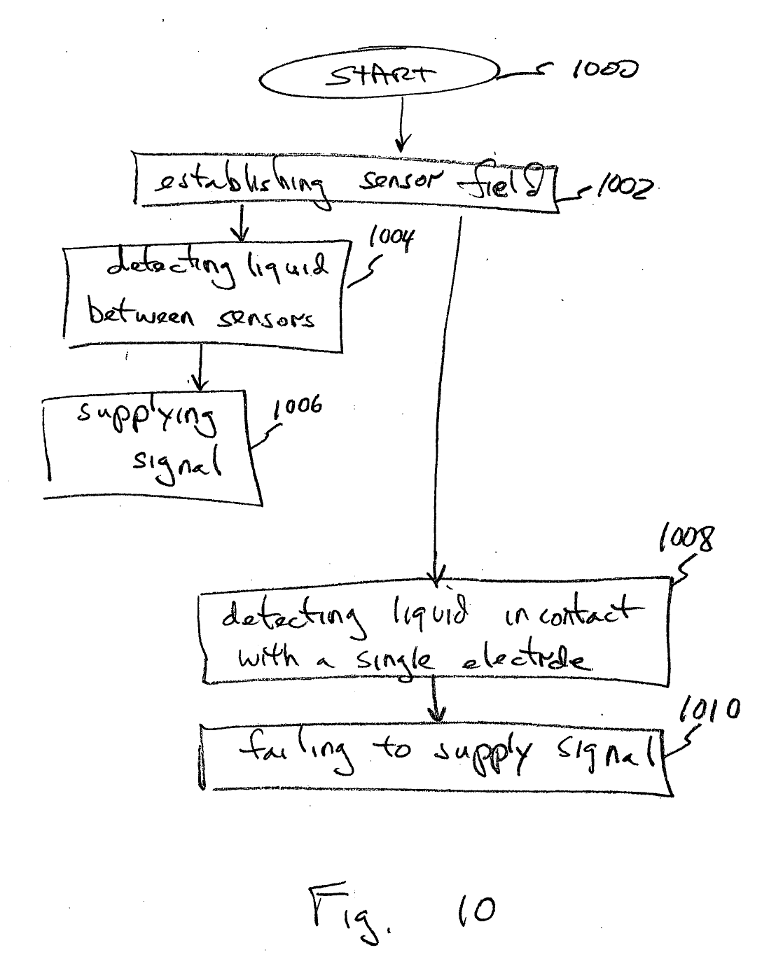

FIGS. 9A through 9C are detailed drawings of some vessel-integral sensor designs. FIG. 9A depicts a sensor formed as a conductive ink pattern 900 formed on the bathtub sides 804. The conductive ink 900 is typically connected to a conductive wire 108 embedded in the vessel underlying the ink pattern. The conductive ink pattern 900 can be part of a decorative pattern formed in the vessel 802, or the ink color can be made to blend into the color of the vessel. The invention is not limited to any particular type of pattern. It is known to use conductive ink in the fabrication of electric circuitry on t-shirts, toys, and disposable electronics. These inks permit low-cost offset printing processes to be used in large-scale manufacturing. Conductive inks are manufactured by T-Ink, Seiko Epson, and E Ink, to name a few manufactures.

FIG. 9B is a partial cross-sectional view of a low-profile conductive metallic electrode 902 formed in a vessel side 804. The electrode 902 can be formed as part of an overall design or colored to match the color of the surrounding vessel side 804. Alternately, element 902 can be part of an optical receiver/transmitter pair, or an optical transceiver and reflector pair.

FIG. 9C is a partial cross-sectional view of a low-profile conductive metallic tape 904 formed in a vessel side 804. The tape 904 can be formed as part of an overall design or colored to match the color of the surrounding vessel side 804. In addition to being embedded, level with the vessel wall 804 (not shown), the tape 904 can be formed overlying the vessel wall 804.

Returning to FIG. 8, in some aspects the system 800 further comprises an alarm unit 502 having an input connected to the detection signal interface 108 to receive the signal from the first set of sensors 200, and an output on line 506 to supply an alarm signal. Details of the alarm unit 502 have been provided in the explanations of FIGS. 5 and 6, and will not be repeated here in the interest of brevity.

In other aspects, the system 800 comprises a second set of sensors 600 (600a and 600b) mounted on the interior sides 804 of the vessel 802 in a second horizontal plane 602, below the first horizontal plane 104. Again, the second set of sensors can be connected to the alarm unit 502, and the details are presented in the description of FIG. 6.

In a different aspect, the system 800 further comprises a liquid regulator 820 having an input on line 506 to accept the alarm signal from the alarm unit 502. The regulator 820 is shown in-line to a faucet or valve 821, and has an output 822 to supply liquid into the vessel 802. The liquid regulator 820 interrupts the flow of liquid in response to the alarm signal on line 506. Alternately but not shown, the regulator could be place in-line after the faucet 821, as opposed to before the faucet (as shown).

FIG. 10 is a flowchart illustrating a method for detecting the overflow of liquid in a vessel. The method starts at Step 1000. Step 1002 establishes a field of sensors in a vessel first horizontal plane. Step 1004 detects a liquid between the sensors. Step 1006 supplies a signal in response to detecting the liquid.

In one aspect, establishing the field of sensors in the vessel first horizontal plane (Step 1002) includes mounting a first set of sensors to interior sides of the vessel. In a different aspect, Step 1002 establishes a sensor field with at least two electrodes. Then, detecting a liquid between the sensors in Step 1004 includes simultaneously detecting liquid in contact with two electrodes. In a different aspect, detecting a liquid in Step 1004 includes measuring a resistance between the two electrodes.

In another aspect, Step 1008 detects liquid in contact with a single electrode, and Step 1010 fails to supply a signal in response to single-electrode liquid contact.

Trans-surface water detection systems and methods have been provided. Examples of various types of sensors have been given. However, the invention is not limited to merely these examples. Examples have also been given of means of connecting these sensors and forming the connected sensors into a field. Again, examples have been given to clarify the invention, and the invention cannot be limited to just the examples. Particular attention has been made of bathtub applications, however, the invention is also applicable to industrial vessels. Other variations and embodiments of the present invention will occur to those skilled in the art.

1. A liquid-surface detection assembly comprising:
a trans-surface liquid detection field aligned in a first horizontal plane; and,
a detection signal interface to supply a signal responsive to the detection of liquid surface across the liquid detection field.

2. The liquid-surface detection assembly of claim 1 wherein the trans-surface liquid detection field includes a first set of sensors with horizontal plane mounting interfaces; and
wherein the detection signal interface supplies a signal responsive to the measurement of electrical resistance between sensors in the first set.

3. The liquid-surface detection assembly of claim 2 wherein the horizontal plane mounting interfaces are selected from the group comprising tub-edge clips, suction cup with visual alignment markers, adhesive backing with visual alignment markers, and partial tub-side hangers.

4. The liquid-surface detection assembly of claim 2 further comprising:
an alarm unit having an input connected to the detection signal interface to receive signals from the first set of sensors, and an output to supply an alarm signal.

5. The liquid-surface detection assembly of claim 4 wherein the alarm unit includes a controller having an input to receive the signals from the first set of sensors, the controller having an output to supply the alarm signal in response to an analysis of factors selected from a measured resistance value, the time duration of a resistance value measurement, the duration between measurements of a resistance value, and the frequency of a measured resistance value.

6. The liquid-surface detection assembly of claim 4 wherein the alarm unit includes a wireless transmitter and antenna to transmit a wireless alarm signal.

7. The liquid-surface detection assembly of claim 2 wherein the trans-surface liquid detection field includes a second set of sensors with mounting interfaces for alignment in a second horizontal plane, below the first horizontal plane;
wherein the detection signal interface supplies a signal responsive to a measurement of electrical resistance between sensors in the second set; and
the sensor further comprising:
an alarm unit having an input connected to the detection signal interface to receive the signals associated with the first and second sets of sensors, and an output to supply a full signal in response to signals associated with the second set of sensors and an alarm signal in response to signals associated with the first set of sensors.

8. The liquid-surface detection assembly of claim 2 wherein the sensor is an element selected from the group comprising an electrically conductive metallic electrode, metallic tape, conductive ink strip, an optical transmitter and receiver, and an optical transceiver and reflector pair.

9. The liquid-surface detection assembly of claim 1 wherein the trans-surface liquid detection field is a single-station sensor, comprising a pair of electrically conductive electrodes, and selected from the group including a grid-covered sensor and a sieve-covered sensor.

10. A liquid vessel with overflow protection, the system comprising:
a vessel with interior sides; and
a first set of sensors mounted to the interior sides of the vessel;
a detection signal interface to supply a signal responsive to the detection of a liquid between the sensors.

11. The system of claim 10 wherein the first set of sensors is aligned in a first horizontal plane.

12. The system of claim 10 wherein the sensors are an element selected from the group including conductive ink patterns formed on the bathtub sides, conductive metallic electrodes, metallic tape formed on the bathtub sides, an optical transmitter and receiver pair, and an optical transceiver and reflector pair.

13. The system of claim 10 wherein the detection signal interface supplies a signal responsive to the measurement of electrical resistance between sensors in the first set.

14. The system of claim 13 further comprising:
an alarm unit having an input connected to the detection signal interface to receive the signal from the first set of sensors, and an output to supply an alarm signal.

15. The system of claim 14 wherein the alarm unit includes a controller having an input to receive the signals from the first set of sensors, the controller having an output to supply the alarm signal in response to an analysis of factors selected from a resistance value, the time duration of a resistance value measurement, the duration between measurements of a resistance value, and the frequency of a measured resistance value.

16. The system of claim 14 wherein the alarm unit includes a wireless transmitter and antenna to transmit a wireless alarm signal.

17. The system of claim 14 further comprising:
a liquid regulator having an input to accept the alarm signal from the alarm unit and an output to supply liquid into the vessel, the liquid regulator interrupting the flow of liquid in response to the alarm signal.

18. The system of claim 11 further comprising:
a second set of sensors mounted on the interior sides of the vessel in a second horizontal plane, below the first horizontal plane;
wherein the detection signal interface supplies a signal responsive to the detection of liquid between sensors in the second set; and
the system further comprising:
an alarm unit having an input connected to the detection signal interface to receive the signals associated with the first and second sets of sensors, and an output to supply a full signal in response to signals associated with the second set of sensors and an alarm signal in response to signals associated with the first set of sensors.

19. A liquid-containing vessel overflow detector, the overflow detector comprising:
liquid detection sensors with vessel mounting interfaces; and,
a detection signal interface to supply a signal responsive to the detection of liquid by the sensors.

20. The overflow detector of claim 19 wherein the sensor mounting interfaces are selected from the group comprising tub-edge clips, suction cups, adhesive backing, partial tub-side hangers, non-liquid-soluble putty, magnetic, and bolt-mounted.

21. The overflow detector of claim 19 further comprising:
an alarm unit having an input connected to the detection signal interface to receive signals from the sensors, and an output to supply an alarm signal.

22. The overflow detector of claim 19 wherein the sensors comprise a pair of electrically conducted electrodes embedded in a single-station selected from the group including a grid-covered sensor and a sieve-covered sensor.

23. A trans-surface overflow detector comprising:
a pair of electrically conductive electrodes;
a detection signal interface to supply a signal responsive to the detection of liquid between the electrodes; and
a housing to at least partially cover the electrodes.

24. The detector of claim 23 wherein the electrodes are mounted on opposite sides of a circuit board.

25. The detector of claim 24 wherein the circuit board has a width; and
wherein the housing is a tube having an inside diameter greater than the circuit board width to accept the circuit board.
